(19) United States
(12) Patent Application Publication
(10) Pub. No.: US 2024/0347267 A1
(43) Pub. Date: Oct. 17, 2024

(54) POWER MODULE WITH FLAT COPPER WINDING

(71) Applicant: TEXAS INSTRUMENTS INCORPORATED, Dallas, TX (US)

(72) Inventors: Yi YAN, San Jose, CA (US); Hidetoshi INOUE, Richardson, TX (US)

(21) Appl. No.: 18/299,830

(22) Filed: Apr. 13, 2023

(51) Int. Cl. H01F 27/40; H01F 27/06; H01F 27/24; H01F 27/29; H01F 41/04

(52) U.S. Cl. CPC H01F 27/40; H01F 27/06; H01F 27/24; H01F 27/29; H01F 41/04

(57) ABSTRACT

An apparatus includes a magnetic core and an inductor. The magnetic core has a cylindrical boss and a base plate. The cylindrical boss has a first end and a second end. The base plate extends perpendicularly from the first end of the cylindrical boss. The base plate has a top side and a bottom side. The inductor includes a coil, a first terminal, and a second terminal. The coil is disposed on the top side of the base plate about the cylindrical boss. The first terminal is wrapped from the top side of the base plate to the bottom side of the base plate. The second terminal is wrapped from the top side of the base plate to the bottom side of the base plate.

### BACKGROUND

Inductors can be used in many applications. For example, inductors can be used in proximity sensing, energy storage, actuation, power transmission, and filtering applications. An inductor can store energy in a magnetic field when electric current flows through the inductor, and can thereafter discharge the stored energy to provide an electric current. The inductor may be coupled to or may be part of an integrated circuit or circuit module, which can include circuitry that operates with the inductor. In some examples, the inductor and the circuitry coupled to the inductor can be enclosed in a modular package, which can reduce the footprint of the circuitry and shorten the interconnects between the inductor and the circuitry.

### SUMMARY

In one example, an apparatus includes a magnetic core and an inductor. The magnetic core has a cylindrical boss and a base plate. The cylindrical boss has a first end and a second end. The base plate extends perpendicularly from the first end of the cylindrical boss. The base plate has a top side and a bottom side. The inductor includes a coil, a first terminal, and a second terminal. The coil is disposed on the top side of the base plate about (around) the cylindrical boss. The first terminal is wrapped from the top side of the base plate to the bottom side of the base plate. The second terminal is wrapped from the top side of the base plate to the bottom side of the base plate.

In another example, a method includes positioning a coil of an inductor around a cylindrical boss of a magnetic core, and on a top surface of a base plate of the magnetic core to form an inductor assembly. The method also includes bending a first terminal and a second terminal of the inductor around an edge of the base plate from the top surface to a bottom surface of the base plate of the magnetic core.

In a further example, a circuit includes a substrate, an inductor assembly, and an integrated circuit. The inductor assembly is coupled to the substrate. The inductor assembly includes a magnetic core and an inductor. The magnetic core has a cylindrical boss and a base plate. The cylindrical boss has a first end and a second end. The base plate extends perpendicularly from the first end of the cylindrical boss. The base plate has a top side and a bottom side. The inductor includes a coil, a first terminal, and a second terminal. The coil is disposed on the top side of the base plate about the cylindrical boss. The first terminal is wrapped from the top side of the base plate to the bottom side of the base plate. The second terminal is wrapped from the top side of the base plate to the bottom side of the base plate. The integrated circuit is coupled to the substrate beneath the inductor assembly. The integrated circuit is configured to drive the inductor.

### BRIEF DESCRIPTION OF THE DRAWINGS

FIGS. 1A, 1B, and 1C are top, back and perspective views of an example module that includes an inductor with a flat winding on a magnetic core.

FIG. 2 is a flow diagram of an example method for fabricating a module that includes an inductor with a flat winding on a magnetic core and an integrated circuit.

FIGS. 3-12 show examples of fabrication of a module according to the method of FIG. 2.

### DETAILED DESCRIPTION

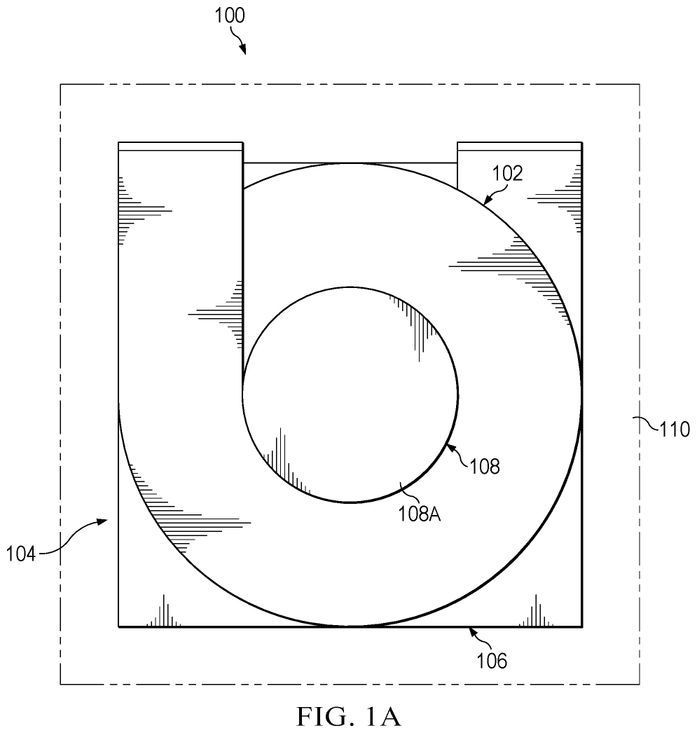

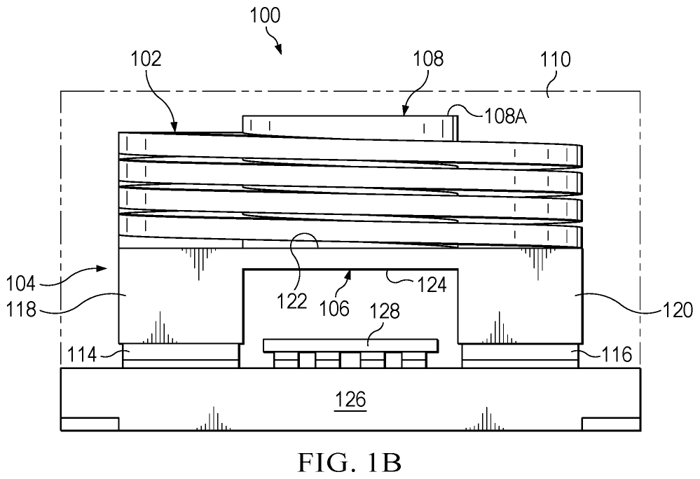

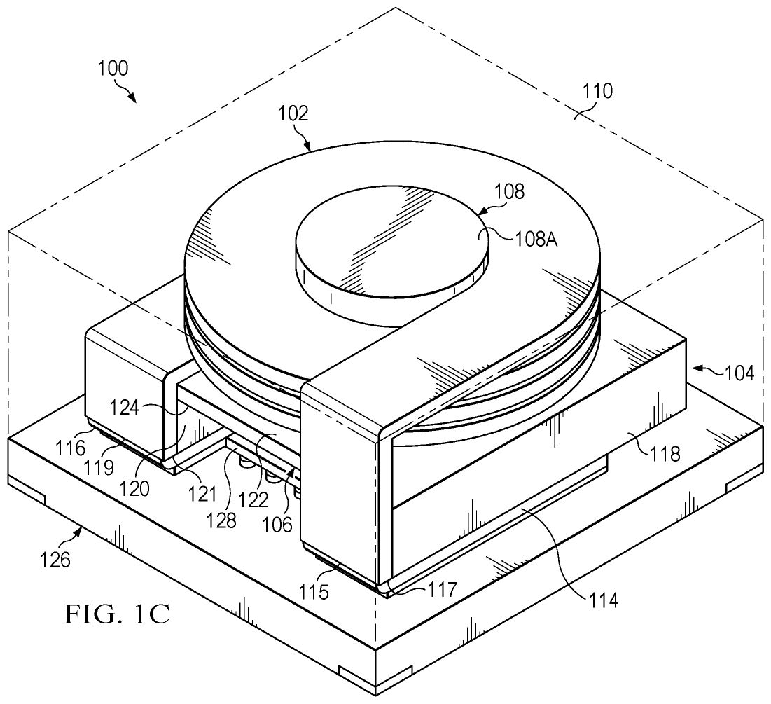

FIGS. 1A, 1B, and 1C are top, back and perspective views of an example power module 100. The power module 100 includes an inductor 102, a magnetic core 104, a substrate 126, an integrated circuit 128, and magnetic mold compound 110. The inductor 102 is wound from a flat conductor (e.g., a flat copper conductor) and includes a coil, a first terminal 114 and a second terminal 116. The coil is wound as a spiral with the thinner sides of the flat conductor forming the inner and outer edges of the coil, and the broader flat sides of the flat conductor opposite one another (one broad flat side of the conductor facing an opposing broad flat side of the flat conductor). The inductor 102 formed from the flat conductor provides a given inductance with fewer turns than would be needed using a cylindrical conductor. The resistance of the inductor 102 is also lower than the resistance of an inductor having the same inductance formed from a cylindrical conductor. However, the inductor 102 may be incompatible with pick and place equipment used to place the inductor 102 on the substrate 126 because the inductor 102 lacks a flat surface that can be reliably engaged by a vacuum collet of the pick and place equipment.

The magnetic core 104 includes a cylindrical boss 108 extending from a base plate 106. The magnetic core 104 may be made of a ferrite material to increase the inductance of the inductor assembly including the inductor 102 and the magnetic core 104. The cylindrical boss 108 has a first end and a second end. The base plate 106 extends perpendicularly from the first end of the cylindrical boss 108. The base plate 106 has a top side 122 and a bottom side 124. The inductor 102 rests on the top side 122 of the base plate 106, and the coil surrounds the cylindrical boss 108. The cylindrical boss 108 extends though the center of the coil with the flat sides of the conductor perpendicular to the cylindrical surface of the cylindrical boss 108. The second end of the cylindrical boss 108 (top surface 108A in FIGS. 1A, 1B, and 1C) provides a flat surface for reliable engagement of the pick and place equipment.

The magnetic core 104 has a first foot 118 and a second foot 120 extending from the bottom side 124. The foot 118 may run along one side of the magnetic core 104 extending from the bottom side 124, and the foot 120 may run along the other side of the magnetic core 104 extending from the bottom side 124. In some examples of the power module 100, the width of the foot 118 and the width of the foot 120 may be a fraction (e.g., ¼) of the width of the magnetic core 104. The width of the foot 118 and the width of the foot 120 may be approximately the same as the width of the flat conductor of the inductor 102 in some examples.

The terminals 114 and 116 are formed at ends of the flat conductor by removing the insulation from the flat conductor. For example, in FIG. 1C the insulation ends at edges 115 and 117, the terminal 114 extends therefrom. Similarly, the insulation ends at edges 119 and 121, and the terminal 116 extends therefrom. Accordingly, the flat conductor of the 102 may include the terminals 114 and 116. The terminal 114 and the terminal 116 are wrapped about (around) an edge of the magnetic core 104 from the top side 122 to the bottom side 124. As shown in FIGS. 1B and 1C, the terminal 114 may be wrapped from the top side 122 to the bottom side 124 and the bottom of the foot 118, and the terminal 116 may be wrapped from the top side 122 to the bottom side 124 and the bottom of the foot 120. The terminal 114 and the terminal 116 may be coupled to metal (e.g., copper) pads of the substrate 126 by solder or other conductive fastening means.

Without the magnetic core 104, in attempting to pick and place the inductor 102, pressure applied to the inductor 102 by a pick and place machine during placement can deform the inductor 102, and potentially short the inductor 102 to other components of the power module 100 (e.g., the inductor 102 may make contact with the integrated circuit 128). With the magnetic core 104 and the inductor 102 arranged as described herein, the inductor 102 is protected from deformation during placement because pressure applied to the magnetic core 104 is transferred through the magnetic core 104 to the terminal 114 and the terminal 116 and the substrate 126.

The integrated circuit 128 may be coupled to the substrate 126 by solder or other conductive fastening means. The integrated circuit 128 may be coupled to the inductor 102 via conductive traces of the substrate 126. The integrated circuit 128 may include power stage circuitry, such as switching transistors for charging and discharging the inductor 102. Some examples of the integrated circuit 128 may also include control circuitry for controlling the switching transistors.

The substrate 126 may be a printed circuit board made of fiberglass, plastic, ceramic, or other material. The substrate 126 may include metal (e.g., copper) pads for connecting to the terminal 114, the terminal 116, and terminals (solder balls, solder pillars, metal pins, metal pads, etc.) of the integrated circuit 128. The substrate 126 may also include metal (e.g., copper) interconnects (traces) coupling the metal pads to form a circuit.

Magnetic mold compound 110 encapsulates the inductor 102, the magnetic core 104, and the integrated circuit 128. The magnetic mold compound may include metal particles that are coated with a first insulation material, and a second insulation material in which the coated metal particles are suspended. The magnetic mold compound 110 protects the inductor 102, the magnetic core 104, and the integrated circuit 128, and increases magnetic field density and the inductance of the inductor 102. Including the magnetic core 104 and the magnetic mold compound 110 to increase the inductance of the inductor 102 allows the size of the power module 100 to be reduced relative to other power module implementations with similar inductance (e.g., power module implementations using packaged inductors).

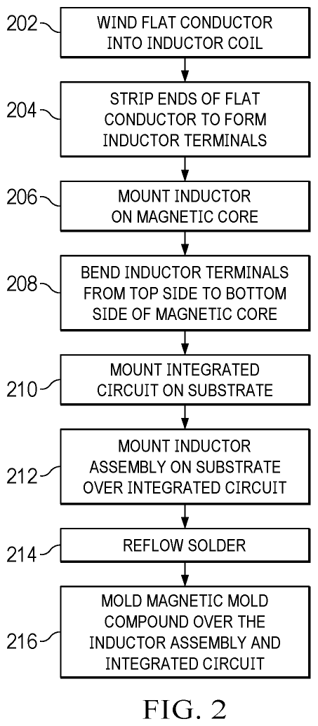

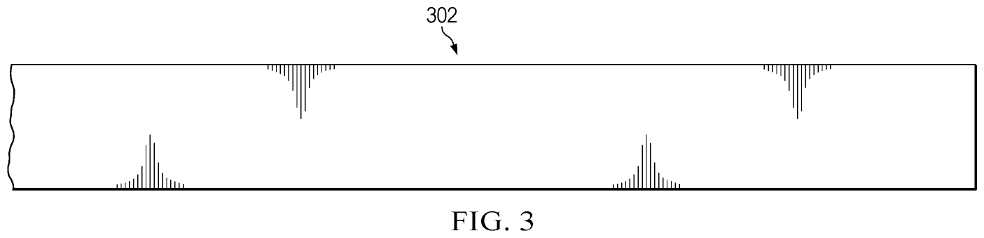

FIG. 2 is a flow diagram of an example method 200 for fabricating the power module 100. Though depicted sequentially as a matter of convenience, at least some of the operations shown can be performed in a different order and/or performed in parallel. Additionally, some implementations may perform only some of the operations shown. Operations of the method 200 are explained by reference to FIGS. 3-12.

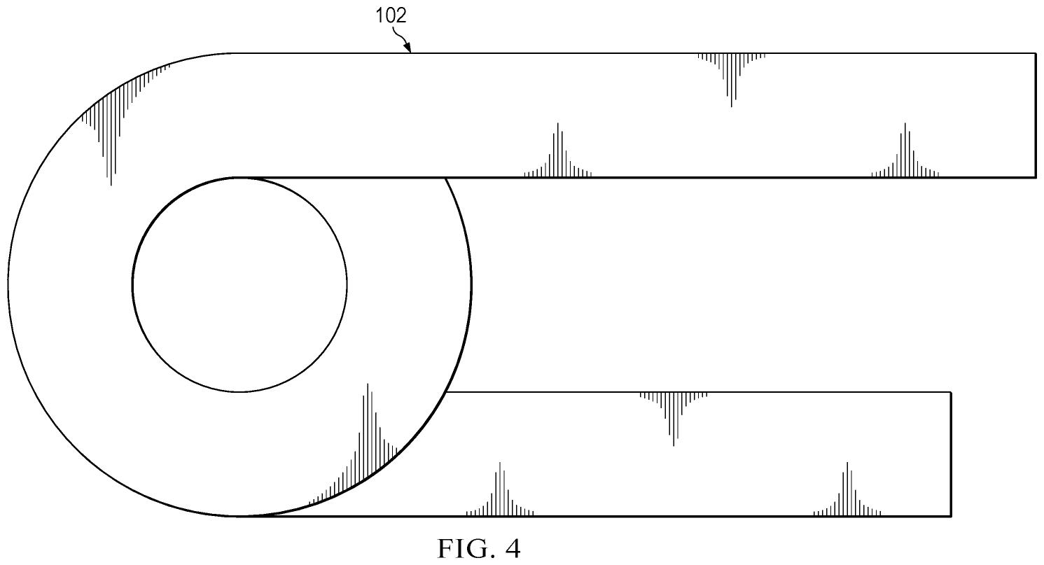

In block 202, a length of flat conductor 302 shown in FIG. 3 is wound to form the inductor 102 shown in FIG. 4. The flat conductor 302 may be a coated copper conductor (e.g., enamel coated) in some examples. The flat conductor 302 may have a width of about 0.5-0.65 millimeters in some examples. The flat conductor 302 may have a thickness of about 0.1 millimeter to 0.12 millimeters in some examples. The number of turns provided in the inductor 102 may be specified to provide a desired inductance with consideration of the magnetic core 104 and the magnetic mold compound 110. For example, the flat conductor 302 may be wound to form 3-5 turns (or any other number of turns as needed) of the flat conductor 302. The coil formed by winding the flat conductor 302 may form a central air core have a diameter of 1 millimeter to 1-4 millimeters, or any other diameter as needed.

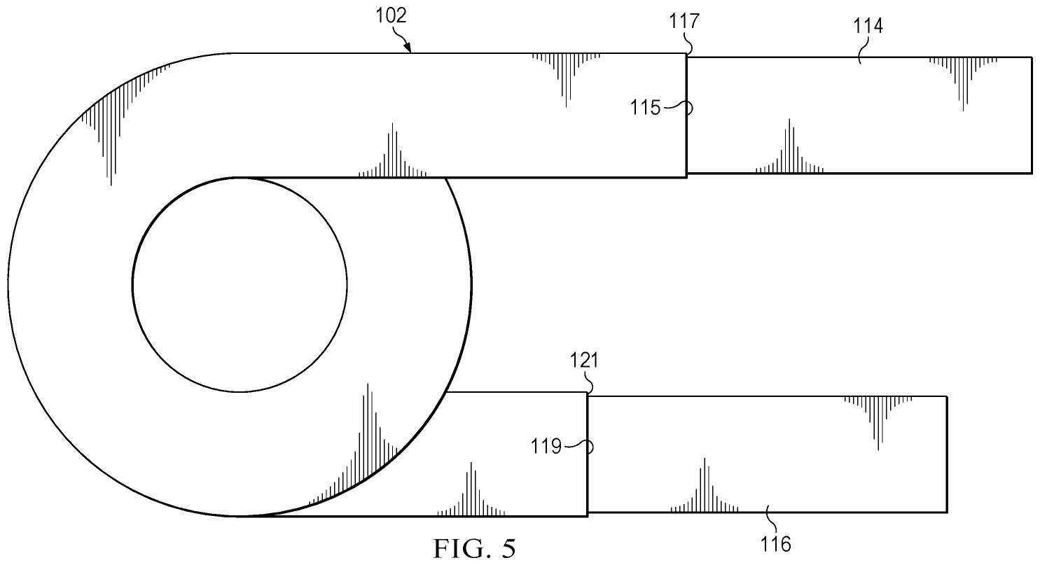

In block 204, the insulation (e.g., the coating) is removed from the two ends of the flat conductor 302 to expose the copper of the flat conductor 302 and form the terminal 114 and the terminal 116 as shown in FIG. 5.

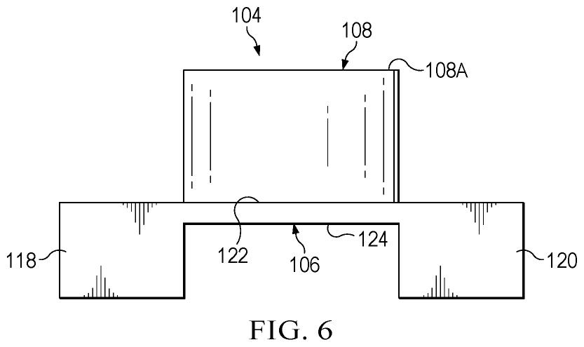

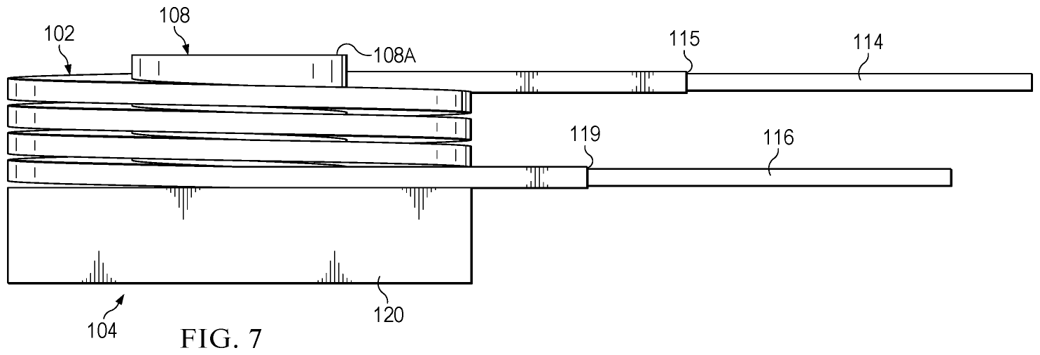

In block 206, the inductor 102 is mounted on the magnetic core 104. FIG. 6 is a front view of the magnetic core 104. FIG. 7 is a side view of the inductor 102 placed on the magnetic core 104, with the cylindrical boss 108 passing through the coil and the terminal 114 and terminal 116 extending to the side.

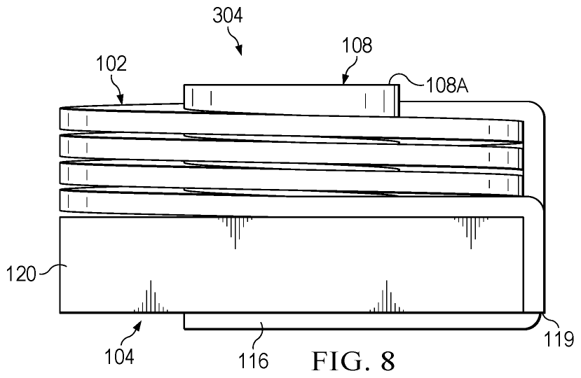

In block 208, the terminal 114 and the terminal 116 are bent from the top side 122 to the bottom side 124 of the base plate 106. In some implementations, the terminal 114 is bent to place the terminal 114 on the bottom of the foot 118, and the terminal 116 is bent to place the terminal 116 on the bottom of the foot 120. FIG. 8 is a side view of the inductor assembly 304 showing the terminal 116 bent from the from the top side 122 to the bottom side 124 of the base plate 106 and placed on the bottom of the foot 120.

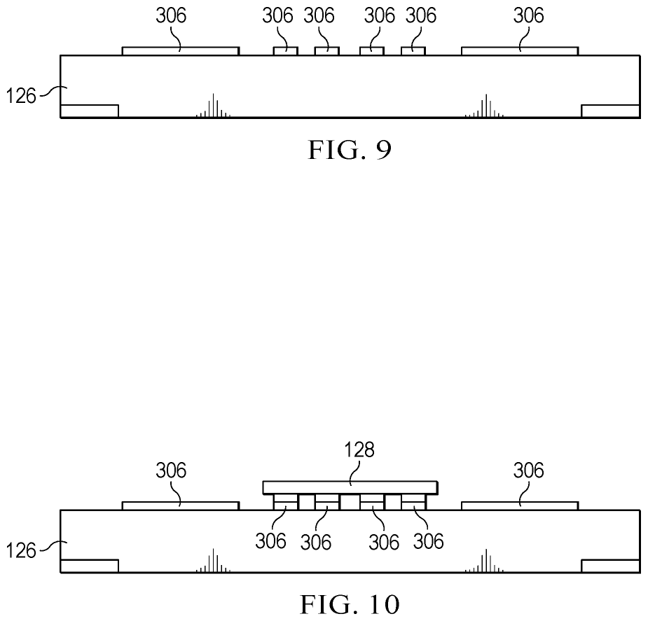

In block 210, the integrated circuit 128 is mounted onto the substrate 126. The substrate 126 may include solder paste 306 patterned onto metal pads of the substrate 126 corresponding to terminals of the integrated circuit 128. FIG. 9 shows the substrate 126 and patterned solder past 306. FIG. 10 shows the integrated circuit 128 after placement on the substrate 126, by, for example, a pick and place machine.

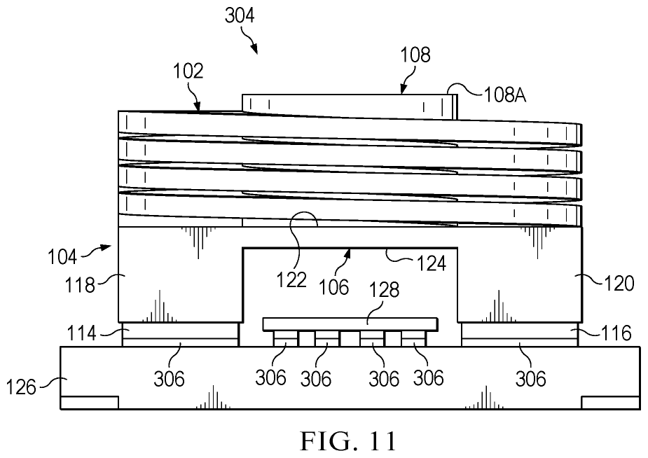

In block 212, the inductor assembly 304 (including the inductor 102 and the magnetic core 104) is mounted on the substrate 126. A pick and place machine may engage the top surface 108A of the cylindrical boss 108 of the magnetic core 104 to move the inductor assembly 304 into position such that the terminal 114 and the terminal 116 of the inductor 102 are aligned with corresponding metal pads of the substrate 126 and in contact with solder paste previously applied to the metal pads. The inductor assembly 304 may be positioned over the integrated circuit 128, such that the integrated circuit 128 is positioned between the terminal 114 and the terminal 116. FIG. 11 shows the inductor assembly 304 placed on the substrate 126 over the integrated circuit 128.

In block 214, the circuit assembly including the substrate 126, the integrated circuit 128, and the inductor assembly 304 may be heated (e.g., in an oven) to reflow the solder paste coupling the integrated circuit 128 and the inductor assembly 304 to the substrate 126, and form solder joints.

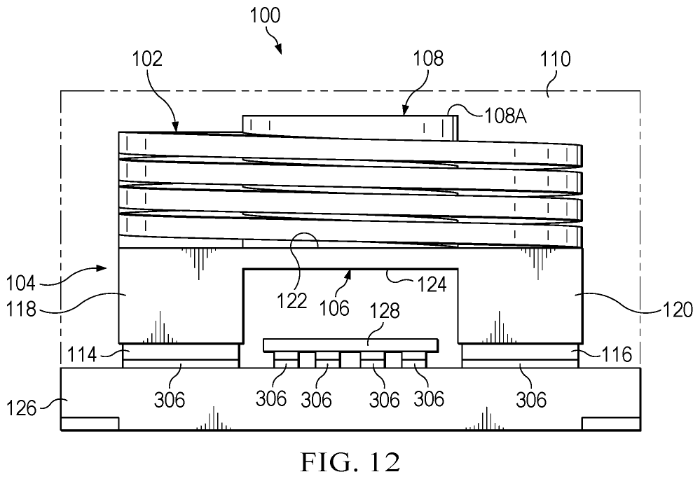

In block 216, the magnetic mold compound 110 is deposited on the substrate 126, the integrated circuit 128, and the inductor assembly 304. The magnetic mold compound 110 includes coated metal particles. The medical particles are coated with a first insulation material; and a second insulation material, in which the coated metal particles are suspended. The magnetic material can include coated metal particles, where each coated metal particle is coated with insulation layer such as silicon dioxide/phosphate layer, and the coated metal particles are suspended in epoxy resin, to reduce leakage on the diced surface where the epoxy resin may be removed and metal particles may be exposed. The magnetic mold compound 110 can be molded and heated, such that the magnetic mold compound 110 can be hardened to form an encapsulation package for the integrated circuit 128 and the inductor assembly 304. FIG. 12 shows the magnetic mold compound 110 encapsulating the integrated circuit 128 and the inductor assembly 304 to form the power module 100.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

In this description, unless otherwise stated, “about,” “approximately” or “substantially” preceding a parameter means being within +/−10 percent of that parameter or, if the parameter is zero, a reasonable range of values around zero.

Modifications are possible in the described embodiments, and other embodiments are possible, within the scope of the claims.

What is claimed is:

1. An apparatus comprising:
a magnetic core having:
a cylindrical boss having a first end and a second end;
a base plate extending perpendicularly from the first end of the cylindrical boss, the base plate having a top side and a bottom side;
an inductor including:
a coil disposed on the top side about the cylindrical boss;
a first terminal wrapped from the top side to the bottom side; and
a second terminal wrapped from the top side to the bottom side.

2. The apparatus of claim 1, wherein:
the coil includes a flat conductor having a first flat side opposite a second flat side; and
the first flat side and the second flat side are perpendicular to the cylindrical boss.

3. The apparatus of claim 1, further comprising a substrate coupled to the first terminal and the second terminal.

4. The apparatus of claim 3, further comprising an integrated circuit coupled to the substrate.

5. The apparatus of claim 4, wherein the magnetic core includes:
a first foot extending from the bottom side; and
a second foot extending from the bottom side.

6. The apparatus of claim 5, wherein:
the first terminal is wrapped from the top side to the first foot; and
the second terminal is wrapped from the top side to the second foot.

7. The apparatus of claim 5, wherein the integrated circuit is disposed between the first foot and the second foot.

8. The apparatus of claim 1, further comprising magnetic mold compound surrounding the magnetic core and the inductor.

9. A method comprising:
positioning a coil of an inductor around a cylindrical boss of a magnetic core, and on a top surface of a base plate of the magnetic core to form an inductor assembly; and
bending a first terminal and a second terminal of the inductor around an edge of the base plate from the top surface to a bottom surface of the base plate of the magnetic core.

10. The method of claim 9, wherein:
the inductor has a first flat side opposite a second flat side; and
the first flat side and the second flat side are perpendicular to a cylindrical surface of the cylindrical boss.

11. The method of claim 9, further comprising winding a flat conductor to form the inductor.

12. The method of claim 9, further comprising:
bending the first terminal of the inductor around a first foot of the base plate; and
bending the second terminal of the inductor around a second foot of the base plate.

13. The method of claim 12, further comprising placing an integrated circuit on a substrate.

14. The method of claim 13, further comprising:
lifting the inductor assembly via a top surface of the cylindrical boss; and
placing the inductor assembly on the substrate.

15. The method of claim 14, further comprising placing the inductor assembly on the substrate such that the integrated circuit is between the first foot and the second foot.

16. The method of claim 14, further comprising applying a magnetic mold compound over the inductor assembly and the integrated circuit.

17. A circuit comprising:
a substrate;
an inductor assembly coupled to the substrate, the inductor assembly including:
a magnetic core having:
a cylindrical boss having a first end and a second end;
a base plate extending perpendicularly from the first end of the cylindrical boss, the base plate having a top side and a bottom side;
an inductor including:
a coil disposed on the top side about the cylindrical boss;
a first terminal wrapped from the top side to the bottom side; and
a second terminal wrapped from the top side to the bottom side; and
an integrated circuit coupled to the substrate beneath the inductor assembly, the integrated circuit configured to drive the inductor.

18. The circuit of claim 17, wherein:
the coil includes a flat conductor having a first flat side opposite a second flat side; and
the first flat side and the second flat side are perpendicular to the cylindrical boss.

19. The circuit of claim 17, wherein:
the magnetic core includes:
a first foot extending from the bottom side; and
a second foot extending from the bottom side; and
the integrated circuit is between the first foot and the second foot.

20. The circuit of claim 17, magnetic mold compound surrounding the inductor assembly and the integrated circuit.
